(19) United States
(12) Patent Application Publication
(10) Pub. No.: US 2020/0336590 A1
(43) Pub. Date: Oct. 22, 2020

(54) EMERGENCY COMMUNICATION COMMAND MANAGEMENT SYSTEM

(71) Applicant: Beijing Yutian Technology Co. Ltd, Beijing (CN)

(72) Inventor: Libao YAN, Beijing (CN)

(21) Appl. No.: 16/686,937

(22) Filed: Nov. 18, 2019

(30) Foreign Application Priority Data
Apr. 17, 2019 (CN) 201910306984.9

(51) Int. Cl. H04M 3/51; H04M 3/22; H04L 29/12; H04M 3/42; H04N 7/18; G06Q 10/06; G06Q 50/26

(52) U.S. Cl. CPC H04M 3/5116; H04M 3/2254; H04L 61/1594; H04M 3/42382; H04M 2201/42; G06Q 10/0631; G06Q 50/265; H04M 2242/04; H04M 2201/38; H04N 7/181

(57) ABSTRACT

The present invention discloses an emergency communication command management system. The system supports the access of PC terminals and mobile terminals, improves the support ability for emergency disposal by means of mobile Internet access, realizes real-time monitoring of public communication network based on GIS, and achieves information collection and unified management of emergency communication resources. The system can realize interconnection with local government platforms and support the sharing of resources among government departments. The system can obviously improve the communication support ability for emergency response and disposal, and the communication support capability for disaster prevention and mitigation, and provide emergency communication guarantee for all industries and departments involved in emergency management of the communication industry.

### TECHNICAL FIELD

The present invention relates to the field of emergency communication command, in particular to an emergency communication command management system.

### BACKGROUND ART

In recent years, China has severe public security situation, natural disasters and accidents occur frequently, public health events and social security events happen constantly, and there are still threats to national security. The Chinese government attaches great importance to disposal of emergency events, and especially after the 2008 Wenchuan Earthquake, the State Council has put forward higher requirements for emergency disposal. In order to improve the emergency communication disposal ability of emergency events, the Ministry of Industry and Information Technology has formulated and issued the Eleventh Five-Year Plan of National Emergency Communication, which proposes to build an emergency communication command management system, so as to improve the command and dispatch ability of emergency communication in the country.

The country attaches great importance to the development of emergency communication industry. The State Council prints and issues the Guiding Opinions on Accelerating the Emergency Industry, and clearly puts forward the focus on the development of emergency communications, emergency command and other emergency products and services, leading the direction of the development of the emergency communication industry and proposing new requirements. The Ministry of Industry and Information Technology attaches great importance to the construction of the national emergency communication system, organizes the preparation and revision of the National Communication Support Emergency Plan, successively implements the “Twelfth Five-Year” development plan for the national emergency communication, and makes the development of the emergency communication industry as an important task.

According to the analysis of China Emergency Communication Industry Report, the emergency industry is expected to maintain a medium and high-speed growth channel in the next ten years, with an annual market capacity of up to hundreds of billions of Renminbi, and the emergency communications will usher in an important development opportunity and huge space for growth.

At present, the emergency communication industry in China is still in its infancy, the level of development needs to be further improved, the industrial chain is relatively weak, and there are still problems such as product system not sound enough and inadequate market demand.

### CONTENTS OF THE INVENTION

The present invention provides an emergency communication command management system, which can obviously improve the communication support ability for emergency response and disposal, and the communication support capability for disaster prevention and mitigation, and provide emergency communication guarantee for all industries and departments involved in emergency management of the communication industry.

The present invention is realized by the following schemes: an emergency communication command management system includes:

Large Screen for Emergency Command: Large-screen display is divided into peacetime display and wartime display. Daily large screen mainly shows the daily monitoring of public communication network, submission of daily zero report, and the overall situation of emergency resources. Large screens in wartime mainly show the daily monitoring of public communication network, information reporting, emergency disposal and emergency resource scheduling.

Monitoring of Public Communication Network: It mainly realizes that all baseline telecom operators collect relevant network management monitoring information regularly or in real time, can show part of the information on GIS map, display disaster scope, disaster degree, damage of communication facilities, communication interruption and emergency resources in real time and visually, or conduct statistical analysis of data; they also provides important monitoring information for the daily and emergency disposal of the system, and automatically corresponds to the emergency response level according to this kind of monitoring information, prompts users to start corresponding emergency plans, and provides a basis for command and decision-making of leaders.

Management of Emergency Communication Resources: It realizes the management of emergency communication resources, such as emergency vehicles, emergency equipment, emergency personnel, communication support teams, emergency reserves and emergency experts.

Management of Daily Zero Report: The functions of zero report submission and zero report management are included. Zero report submission realizes the functions of daily zero report submission, query of reported list, and display of on-duty information and statistical information. Zero report management mainly realizes the functions of processing, query and statistics of received zero report.

Emergency Drill Management: The functional modules of emergency drill management, emergency drill query and emergency drill statistics are included. Among them, the drill management mainly realizes the formulation of emergency drill plan and contents, emergency drill management, drill task management and other operations. The drill query mainly realizes emergency drill viewing, task feedback and other operations. The drill statistics mainly realize the statistics of different dimensions such as the type of drills, the number of drills and the unit of drills.

Emergency Address Books: It realizes the management of the emergency personnel address book of the unit, and query of the contacts by the retrieval method of keywords such as the name of the unit, the name and post of the emergency personnel.

Information Receiving and Reporting: After an emergency occur, the subordinate unit reports the emergency information, the higher unit receives and processes the reported information, and the leader in charge examines and approves the reported information, and reports events to the superior leader for the closed-loop business process management, and also completes the management of the received information.

Command and Dispatch: Various means of command and dispatch are provided to deal with events according to the event information and the contents and processes of the disposal plan. It assists emergency commanders in effectively deploying and dispatching emergency teams, emergency materials, emergency equipment and other resources, and organize and connect with emergency expert teams. The functions of task tracking, command generation, execution feedback and process supervision are realized and cooperative command, orderly scheduling and effective supervision are also realized to improve emergency response efficiency.

Multimedia Archives Management: It is used to manage a large number of on-site audios, videos, pictures and other multimedia materials produced in the process of event disposal at the emergency scene, emergency management, emergency drills or meetings. The main functions of the system cover the whole process of collecting, processing, storing, filing, organizing, publishing, utilizing and digital management of multimedia archives information, and comprehensively support the storage and query requirements of multimedia information for emergency processing.

Furthermore, the large screen for emergency command mentioned also includes displaying the overall monitoring situation of base stations out of service in the whole province through the large screen, and checking the proportion in base stations out of service by statistics of the first few latest base stations out of service in the current period of time in the province. Switch to view the data collection trend analysis of all provincial companies in the past week. Access to the video surveillance system can switch the video surveillance screens of different event locations.

Furthermore, the public communication network monitoring also includes the comprehensive statistics of equipment, the analysis of changes in the number of equipment interrupted, the statistics of equipment interrupted, the statistics of the degree of equipment out of service and the relational analysis of equipment out of service. Data collection: it mainly includes information collection on the mobile communication network and fixed communication network. The update frequency of data collection: static data is synchronized once a day and dynamic data is synchronized once every 5 minutes.

Furthermore, the emergency communication resource management mentioned also includes the display of emergency communication resources and query of emergency communication resources through GIS, (1) Graphical query: the emergency information can be queried in the scope of the box through dropping down the box on the map, and the detailed information of the materials and teams needed for the emergency can be checked. (2) Attribute Query: query in accordance with the query conditions (fuzzy matching according to the name of emergency resources), and locate emergency resources information (such as the location of rescue teams, materials and social resources.) on the map for display.

Furthermore, the emergency address book mentioned also includes calling the person in charge of the emergency directly through IP phone and sending daily monitoring information by text message and WeChat.

Furthermore, the information reporting mentioned also includes event re-reporting, event update, event study and determination, and report receiving-management.

Furthermore, the report-receiving management mentioned also includes functions of information approval, return and re-report, printing and submitting for approval, event synthesis and information modification.

Furthermore, the command and dispatch mentioned also includes functions of emergency disposal, scheme management and summary evaluation.

Furthermore, the emergency disposal mentioned referring to the overall process flow of emergency events, includes the start of plans, historical plans for reference, graphic plans, event information, plan information, participation departments, resource scheduling, task tracking, relevant knowledge and cases, relevant laws and regulations, etc.

Furthermore, the summary and evaluation mentioned also includes emergency evaluation, evaluation report query and evaluation index management, referring to a comprehensive assessment of the whole emergency process based on evaluation indexes of emergency teams, emergency materials and emergency equipment, and generating event disposal evaluation report.

Furthermore, the multimedia archives management mentioned also includes the multimedia file management, multimedia archives management, multimedia archives query and multimedia archives statistics.

Compared with the existing technology, the present invention has the following advantages and beneficial effects:

The present invention provides an information collection and unified management of emergency communication resources based on big data technology, improves the support ability for emergency disposal by means of mobile Internet access, and realizes real-time monitoring of public communication network based on GIS, and achieves obvious improvements of communication support capability for emergency response and disposal, and communication support capability for disaster prevention and mitigation.

### ILLUSTRATIONS

In order to make contents of the present invention understood more easily and clearly, the present invention is further described in detail in accordance with specific embodiments of the present invention and figures, where

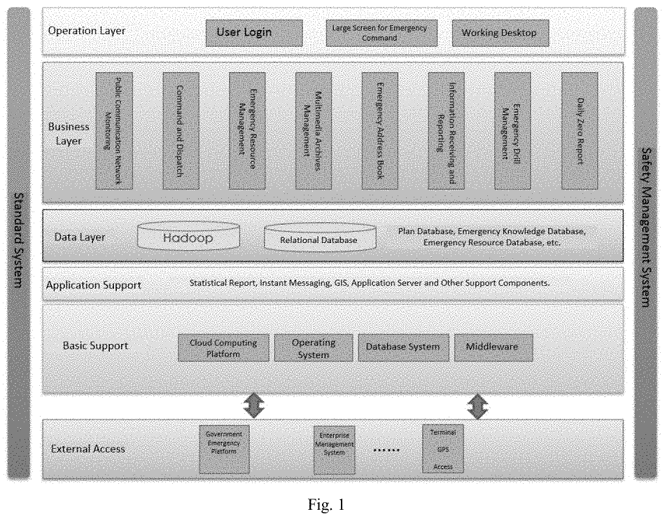

FIG. 1 shows the architecture of an emergency communication command management system in an embodiment of the present invention.

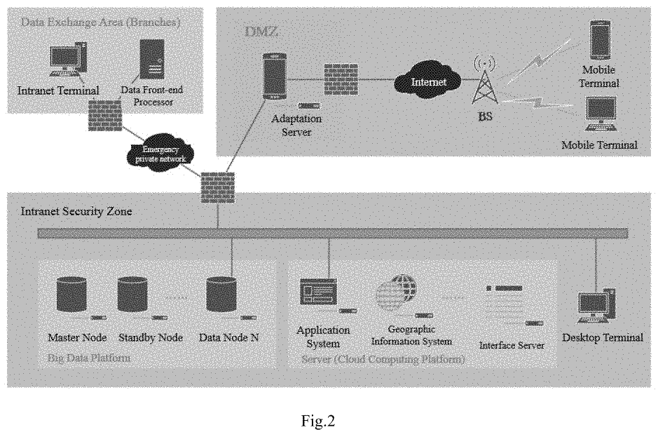

FIG. 2 shows the deployment of an emergency communication command management system in an embodiment of the present invention.

### EMBODIMENTS

The following contents are detailed descriptions for embodiments of the present invention combined with figures. The following embodiments are used to describe the present invention but are not used to limit the scope of the present invention.

### Embodiment 1

As shown in FIG. 1, the present invention provides the architecture diagram of an emergency communication command management system. The technical framework of the system adopts a technical architecture combining Spring, Struts, Hibernate, AngularJs and H5. The system adopts service-oriented SOA software architecture and MVC design pattern, and adopts Web Service to realize interface development, information transmission and other technical schemes, so as to ensure the advancement and stability of the system development technology.

The overall logical framework of emergency communication command management system is divided into external accesslayer, basic support layer, application support layer, data layer, business application layer and operation layer from bottom to top. The above layers separately provide the corresponding data access and storage services, general supporting component services, basic support platform services to support development and operation, and specific business applications realized by underlying components and services, and show specific business applications to end users.

1. External Access

The access of enterprise network management system, emergency vehicle GPS terminal, government emergency platform and other systems is realized.

2. Basic Support System

The basic support system is the infrastructure of the whole emergency platform, including cloud computing platform, computer network, server, storage and operating system, database, J2EE application server, etc.

3. Application Support Layer

The application support platform provides basic technical services and single business services for emergency business system. The application support includes support components of emergency platforms, statistical report management, instant messaging tools, geographic information software, etc.

4. Data Resource Layer

Data resource layer provides mechanism of data storage, management and resource access, and provides data and resource services for the above layers. The project mainly constructs data repositories such as basic information database, spatial database, network resource database, event database, plan database, emergency resource database, knowledge database, case database, document database and monitoring information database.

The big data platform adopts the architecture of HADOOP+HBASE, provides distributed storage of massive data and high-performance distributed computing framework, and completes data analysis such as public communication network monitoring and emergency resources. All kinds of resources in the system are stored and managed in a unified way, such as emergency plan database, emergency knowledge database, emergency resource database, emergency case database and GIS spatial database. Intelligent search of all kinds of resources in the system is realized.

5. Business Application Layer

As the core of the emergency communication command system, its main business functions include public communication network monitoring, emergency communication resource management, information reporting, report-receiving management, etc.

6. Operation Layer

It is mainly used for user access and responsible for interaction with users to accept users' requests for services to the system and present the processing results of business application layer to users. The presentation layer provides access services to different channels, converts the information accessed by channels into the uniform format required by invoking the service of the business layer through the corresponding channel service objects, and also converts the return results into the format acceptable to each channel.

### Embodiment 2

As shown in FIG. 2, the present invention provides a deployment diagram of an emergency communication command management system. The deployment plan includes:

Emergency communication command management system can be deployed in the intranet security zone, including two application servers for hot standby, two database servers for cluster deployment, one interface server and one GIS server. Big Data Platform: one master node, one standby node and many data nodes (purchase according to the actual situation and business requirements of enterprises) are included and data nodes can be dynamically expanded according to the actual situation. Infrastructure support system can be deployed in cloud computing platform and adopt private cloud deployment. Data collection adopts special lines and enterprise front-end processors (baseline telecom operators) for network connection. Large screens for emergency command and PC terminals use the intranet for access, and mobile terminals use the Internet for access.

What is claimed:

1. An emergency communication command management system is characterized in that:
Large Screen for Emergency Command: Large-screen display is divided into peacetime display and wartime display. Daily large screen mainly shows the daily monitoring of public communication network, submission of daily zero report, and the overall situation of emergency resources, Large screens in wartime mainly show the daily monitoring of public communication network, information reporting, emergency disposal and emergency resource scheduling;
Monitoring of Public Communication Network: It mainly realizes that all baseline telecom operators collect relevant network management monitoring information regularly or in real time, can show part of the information on GIS map, display disaster scope, disaster degree, damage of communication facilities, communication interruption and emergency resources in real time and visually, or conduct statistical analysis of data; they also provides important monitoring information for the daily and emergency disposal of the system, and automatically corresponds to the emergency response level according to this kind of monitoring information, prompts users to start corresponding emergency plans, and provides a basis for command and decision-making of leaders;
Management of Emergency Communication Resources: It realizes the management of emergency communication resources, such as emergency vehicles, emergency equipment, emergency personnel, communication support teams, emergency reserves and emergency experts;
Management of Daily Zero Report: The functions of zero report submission and zero report management are included. Zero report submission realizes the functions of daily zero report submission, query of reported list, and display of on-duty information and statistical information, Zero report management mainly realizes the functions of processing, query and statistics of received zero report;
Emergency Drill Management: It includes three functional modules of emergency drill management, emergency drill query and emergency drill statistics, Among them, the drill management mainly realizes the formulation of emergency drill plan and contents, emergency drill management, drill task management and other operations; The drill query mainly realizes emergency drill viewing, task feedback and other operations; The drill statistics mainly realize the statistics of different dimensions such as the type of drills, the number of drills and the unit of drills;
Emergency Address Books: It realizes the management of the emergency personnel address book of the unit, and query of the contacts by the retrieval method of keywords such as the name of the unit, the name and post of the emergency personnel;
Information Receiving and Reporting: After an emergency occur, the subordinate unit reports the emergency information, the higher unit receives and processes the reported information, and the leader in charge examines and approves the reported information, and reports events to the superior leader for the closed-loop business process management, and also completes the management of the received information;
Command and Dispatch: Various means of command and dispatch are provided to deal with events according to the event information and the contents and processes of the disposal plan. It assists emergency commanders in effectively deploying and dispatching emergency teams, emergency materials, emergency equipment and other resources, and organize and connect with emergency expert teams. The functions of task tracking, command generation, execution feedback and process supervision are realized and cooperative command, orderly scheduling and effective supervision are also realized to improve emergency response efficiency;
Multimedia Archives Management: It is used to manage a large number of on-site audios, videos, pictures and other multimedia materials produced in the process of event disposal at the emergency scene, emergency management, emergency drills or meetings, The main functions of the system cover the whole process of collecting, processing, storing, filing, organizing, publishing, utilizing and digital management of multimedia archives information, and comprehensively support the storage and query requirements of multimedia information for emergency processing.

2. The emergency communication command management system described in the claim 1 is characterized in that the large screen for emergency command mentioned also includes displaying the overall monitoring situation of base stations out of service in the whole province through the large screen, and checking the proportion in base stations out of service by statistics of the first few latest base stations out of service in the current period of time in the province, Switch to view the data collection trend analysis of all provincial companies in the past week. Access to the video surveillance system can switch the video surveillance screens of different event locations.

3. The emergency communication command management system described in the claim 1 is characterized in that the public communication network monitoring also includes the comprehensive statistics of equipment, the analysis of changes in the number of equipment interrupted, the statistics of equipment interrupted, the statistics of the degree of equipment out of service and the relational analysis of equipment out of service. The data collection: it mainly includes information collection on the mobile communication network and fixed communication network. The update frequency of data collection: static data is synchronized once a day and dynamic data is synchronized once every 5 minutes.

4. The emergency communication command management system described in the claim 1 is characterized in that the emergency communication resource management mentioned also includes the display of emergency communication resources and query of emergency communication resources through GIS, (1) Graphic Query: the emergency information can be queried in the scope of the box through dropping down the box on the map, and the detailed information of the materials and teams needed for the emergency can be checked. (2) Attribute Query: query in accordance with the query conditions (fuzzy matching according to the name of emergency resources), and locate emergency resources information (such as the location of rescue teams, materials and social resources.) on the map for display.

5. The emergency communication command management system described in the claim 1 is characterized in that the emergency address book mentioned also includes calling the person in charge of the emergency directly through IP phone and sending daily monitoring information by text message and WeChat.

6. The emergency communication command management system described in the claim 1 is characterized in that the information reporting mentioned also includes event re-reporting, event update, event study and determination, and report-receiving management.

7. The emergency communication command management system described in the claim 6 is characterized in that the report-receiving management mentioned also includes functions of information approval, return and re-report, printing and submitting for approval, event synthesis and information modification.

8. The emergency communication command management system described in the claim 1 is characterized in that the command and dispatch mentioned also includes functions of emergency disposal, scheme management and summary evaluation.

9. The emergency communication command management system described in the claim 8 is characterized in that the emergency disposal mentioned referring to the overall process flow of emergency events, includes the start of plans, the reference of historical plans, graphic plans, event information, plan information, departments participated, resource scheduling, task tracking, relevant knowledge and cases, relevant laws and regulations, etc.

10. The emergency communication command management system described in the claim 8 is characterized in that the summary evaluation mentioned also includes emergency evaluation, evaluation report query and evaluation index management, referring to a comprehensive assessment of the whole emergency process based on evaluation indexes of emergency teams, emergency materials and emergency equipment, and generating event disposal evaluation report.

11. The emergency communication command management system described in the claim 1 is characterized in that the multimedia archives management mentioned also includes the multimedia file management, multimedia archives management, multimedia archives query and multimedia archives statistics.
